(19) United States
(12) Patent Application Publication
(10) Pub. No.: US 2026/0304353 A1
(43) Pub. Date: Oct. 1, 2026

(54) Method of Management of Sidelink Communication

(71) Applicant: Sheng-Liu Lin, Hsinchu City (TW)

(72) Inventor: Sheng-Liu Lin, Hsinchu City (TW)

(21) Appl. No.: 19/382,297

(22) Filed: Nov. 7, 2025

Related U.S. Application Data
(60) Provisional application No. 63/778,437, filed on Mar. 27, 2025.
(60) Provisional application No. 63/828,987, filed on Jun. 24, 2025.

(51) Int. Cl. H04W 64/00; H04W 4/12; H04W 60/04; H04W 92/18

(52) U.S. Cl. CPC H04W 64/00; H04W 4/12; H04W 60/04; H04W 92/18

(57) ABSTRACT

A method of management of sidelink communication by an application software comprises the steps of 1) requesting a UE to activate a sidelink communication; 2) determining the UE's location with the assistance from satellites or a cellular network; 3) receiving an operation report from a sensor; 4) instructing the UE to broadcast a vehicle message periodically via the sidelink communication if the operation report indicates normality; 5) instructing the UE to broadcast the vehicle message via the sidelink communication in an urgent way if the operation report indicates abnormality. The method further comprises a step of 1) instructing the UE to send the vehicle message to the cellular network via a UU interface or 2) camping on and registering to the cellular network before the step of requesting the UE to activate the sidelink communication.

### CROSS REFERENCE TO RELATED APPLICATIONS

This application claims the benefit of U.S. Provisional Application No. 63/778,437, filed on Mar. 27, 2025. Further, this application claims the benefit of U.S. Provisional Application No. 63/828,987, filed on Jun. 24, 2025. The contents of these applications are incorporated herein by reference.

### BACKGROUND OF THE INVENTION

### 1. Field of the Invention

This disclosure generally relates to a method of wireless communication, and more particularly, to a method of management of sidelink communication.

### 2. Description of the Prior Art

V2X (Vehicle-to-Everything) communication refers to V2V (vehicle-to-vehicle), V2I (vehicle-to-infrastructure), V2R (vehicle-to-pedestrian) or V2N (vehicle-to-network) communication. V2V, V2I and V2R refer to direct communication between a vehicle and device. V2N refers to network communication between the vehicle and a 4G/5G network via base stations.

UE (User Equipment), also named a mobile station or mobile terminal, able to be embedded or installed in a vehicle, has the capability of data transmission and reception with a base station (eNodeB, gNodeB or the likes) of a cellular network or from another UE wirelessly. The base station is a part of a RAN (Radio Access Network) which is an entry point of a cellular network.

### SUMMARY OF THE INVENTION

Sidelink is a direct communication technology or interface that implement the functions defined in V2X communication. In certain embodiments we disclose a method of management of sidelink communication.

A method of management of sidelink communication by an application software comprises the steps of 1) requesting a UE to activate a sidelink communication; 2) determining the UE's location with the assistance from satellites or a cellular network; 3) receiving an operation report from a sensor; 4) instructing the UE to broadcast a vehicle message periodically via the sidelink communication if the operation report indicates normality; 5) instructing the UE to broadcast the vehicle message via the sidelink communication in an urgent way if the operation report indicates abnormality. The method further comprises a step of 1) instructing the UE to send the vehicle message to the cellular network via a UU interface or 2) camping on and registering to the cellular network before the step to request the UE to activate the sidelink communication.

A method of management of sidelink communication by an application software comprises the steps of 1) requesting a UE to activate a sidelink communication; 2) determining the UE's location with the assistance from satellites or a cellular network; 3) calculating a distance value by comparing its and a third-party location from a third-party vehicle message received from the sidelink communication; 4) instructing the UE to broadcast a vehicle message periodically via the sidelink communication if the distance value is higher than a threshold; 5) instructs the UE to broadcast the vehicle message via the sidelink communication in an urgent way if the distance value is lower than the threshold. The method further comprises a step of 1) instructing the UE to send the vehicle message to the cellular network via a UU interface or 2) camping on and registering to the cellular network before the step to request the UE to activate the sidelink communication.

A method of management of sidelink communication by an application software comprises the steps of 1) requesting a UE to activate a sidelink communication; 2) determining the UE's location with the assistance from satellites or a cellular network; 3) calculating a distance value by comparing its and a third-party location from a third-party vehicle message received from the sidelink communication; 4) instructing the UE to broadcast a vehicle message periodically via the sidelink communication if the distance value is higher than a threshold; 5) instructs the UE to broadcast the vehicle message via the sidelink communication in an urgent way if the distance value is lower than the threshold. The method further comprises a step of 1) instructing the UE to send the vehicle message to the cellular network via a UU interface or 2) camping on and registering to the cellular network before the step to request the UE to activate the sidelink communication.

The urgent way above is to increase the frequency of broadcasting the vehicle message or disable a power saving mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a device 10.

FIG. 2 illustrates a first embodiment of method of management of sidelink communication.

FIG. 3 illustrates a second embodiment of method of management of sidelink communication.

FIG. 4 illustrates a third embodiment of method of management of sidelink communication.

FIG. 5 illustrates a fourth embodiment of method of management of sidelink communication.

### DETAILED DESCRIPTION

3GPP TS 38.355 v 18.5.0 is a 3GPP standard published on March 21, and discloses a protocol specification of Sidelink Positioning Protocol (SLPP). All the definition of technical terms used in this disclosure may refer to that standard primarily.

V2X (Vehicle-to-Everything) is a mechanism for a UE placed in a vehicle which is able to send messages, sensed data, traffic data, location/position information, or other information to another UE placed in another vehicle, RSU (Roadside Unit), pedestrian or infrastructure. A sidelink communication is disclosed for achieving the above purpose without intervening the operation of a cellular network.

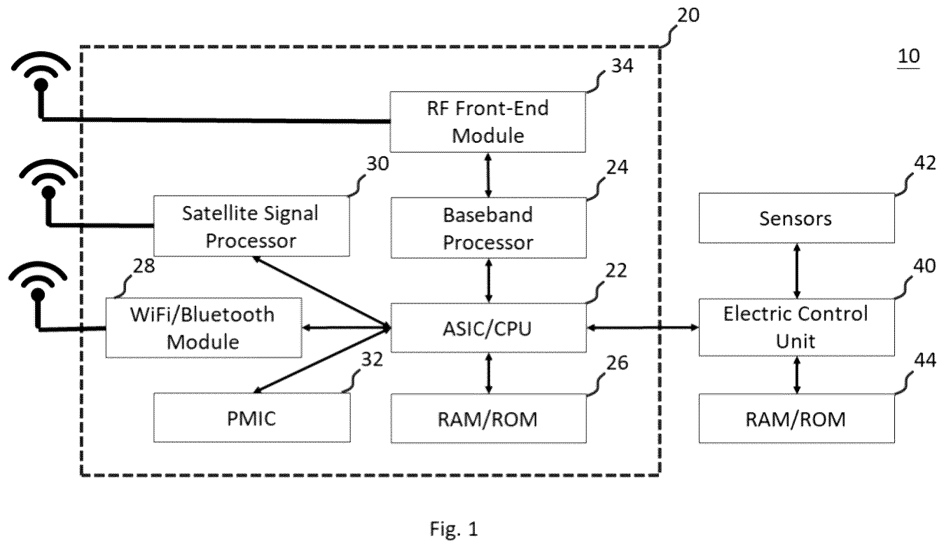

As illustrated in FIG. 1, a UE 20 is a logic unit implemented by a device 10 and has the capability of data transmission with a relay UE, base station, a satellite (relay) or a drone (Unmanned Aerial Vehicle or UAV) of a cellular network. It is preferable that the UE 20 also has the capability of phone calling. The function of the UE 20 is mainly performed by an ASIC/CPU (Application-Specific Integrated Circuit/Central Processing Unit) 22 to execute instructions, procedures or protocols in form of software firmware and so on, and generate digital data and or process received digital data. In order to perform comprehensive functions, the ASIC/CPU 20 may work with Baseband processor 24, RAM/ROM 26, WiFi/Bluetooth Module 28, Satellite Signal Processor 30, PMIC (Power Management IC) 32 and so on.

Baseband processor 24 mainly converts digital data received from the ASIC/CPU 22 into RF (radio frequency) signals, passes the RF signals to RF Front-End Module 34 for amplifying the RF signals for wireless transmission, converts RF signals received from RF Front-End Module 24 into digital data, and passes received digital data to the ASIC/CPU 22 for processing.

RAM/ROM 26 is used to store all the digital data, software and firmware of UE 20.

WiFi/Bluetooth Module 28 provides short-distance communication capacity with another UE or device. Moreover, WiFi/Bluetooth Module 28 is able to provide a non-3GPP connection (either trusted and untrusted connection) to access the cellular network if the connection via the RF Front-End Module 34 does not work.

Satellite Signal Processor 30 is used to receive GNSS (Global Navigation Satellite System) data, such as GPS (Global Positioning System), GLONASS (Global Navigation Satellite System), BDS (Beidou Navigation Satellite System), Galileo and so on, from the satellites or drones. The GNSS data are received/measured and transferred to the ASIC/CPU 22 in order to calculate the location value of the UE 20. The Satellite Signal Processor 30 may have the capability of measurement and process of the GNSS data directly and transfers calculated location to the ASIC/CPU 22. Moreover, the UE 20 is able to connect to a satellite or drone to perform data transmission via the Satellite Signal Processor 30, prefered via a UU interface.

PMIC 32 is mainly to receive and supply power for consumption for each component of the UE 20. The power is received from a power source, such as a battery (not shown), solar panel or fuel cells. The PMIC 32 includes power converter, regulator or booster to convert the received power, either AC (Alternating Current) or DC (direct current), to a DC power before supplying the power to each component of the UE 20.

Device 10 may be a smartphone, glasses, personal computer, laptop computer, sports camera, wireless router, VR (Virtual Reality) device, AR (Augmented Reality) device, drone, vehicle, boat or aircraft. Taking vehicle as an example in the below description, the UE 20 is able to provide the capability of data transmission to transmit the digital data received from an ECU (Electric Control Unit) 40 of device 10 to another UE, and vice versa.

The ECU 40 plays as a CPU of the device 10 and controls a fuel injection, ignition and ancillaries of an engine, operations of a multimedia platform, processes all of the data and signals generated by other components of the device 10 and stores the data into RAM/ROM 44 (or RAM/ROM 26). Due to the extensive capability and technology improvement, ECU 40 may be incorporated into ASIC/CPU 22 and RAM/ROM 44 may be incorporated into RAM/ROM 26.

RAM/ROM 44 functions as RAM/ROM 26 to store all of the digital data, software and firmware of the ECU 40 or Device 10.

Sensor 42 which is used to sense the status of operation of one or more component of the device 10. For example, a brake sense is used to sense the status of operation of brake; a tire pressure sense is used to sense the status of air pressure of a tire or tires; a battery senser is used to sense the operation current, temperature, voltage or air pressure of a battery bank; an altitude sensor is used to measure the pressure to calculate the attitude of the UE 20. The sensor 42 reports a sensed value to the ECU 40 regularly. ECU 40 is able to compare the sensed value with a threshold value to determining a normal state or an abnormal state of the operation. The sensor 42 may have the capability to determine the state directly and pass it to the ECU 40. The threshold is preferable pre-determined but it is workable to provide a user interface allowing a user of the device 10 to set a value. Moreover, another type of sensor which does not sense any operation but reports a switch status may be used as well. For example, a construction engineer can turn on a switch to indicate an operation of construction. When the switch is turned on, it reports a positive or negative value to the EUC 40.

As a software application provider, there is no specific solution of handling the error message received from the sensor 42 or ECU 40, especially how to forward the error message or information to another entity, such as an application server located in the cellular network or another UE, or handling a traffic event, efficiently and promptly. There is a significant demand to have the UE 20 manage the error message or traffic event. 4 embodiments in total are disclosed below to provide solutions to the demand.

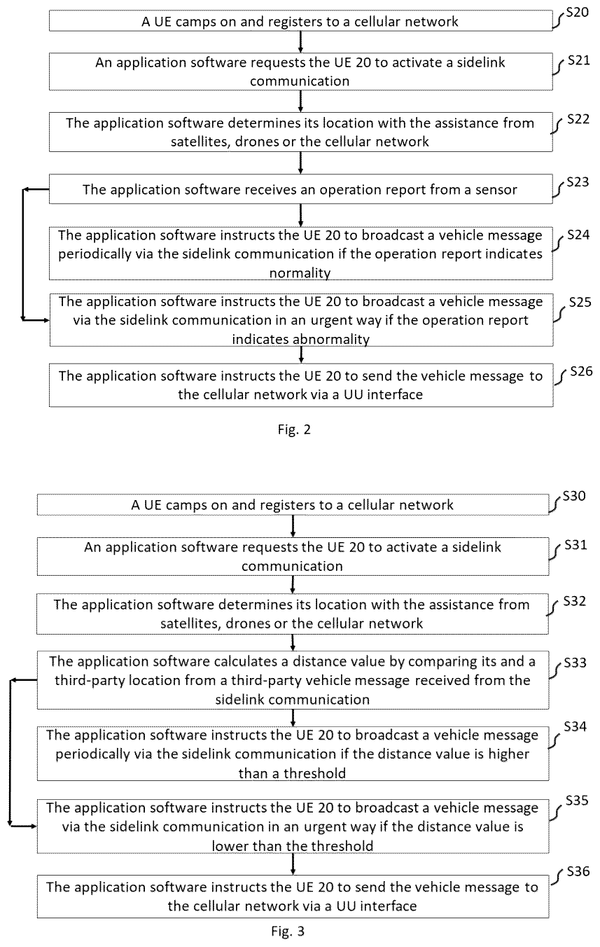

FIG. 2 illustrates the first embodiment of method of management of sidelink communication.
Step S20: A UE 20 camps on and registers to a cellular network. The UE 20 performs a network selection procedure to determine which PLMN (Public Land Mobile Network) or SNPN (Stand-alone Non-Public Network) it attempts to register with. After that the UE 20 performs a cell selection procedure to search and finds a suitable cell to camp on. The cell may refer to a base station, satellite (relay) or drone. If the UE 20 camps on a cell successfully, its RRC state enters an RRC_IDLE state. The UE 20 transmits a RRCSetupRequest message, disclosing the UE identity information, such as SUPI, SUCI (concealed SUPI), or TMSI/5G-S-TMSI, to the cellular network to establish connectivity. When a RRCSetupComplete message is received from the cellular network, a connection with the cellular network via the cell is established (referring to a UU interface) and its RRC state enters an RRC_Connected state from the RRC_IDLE state. The UE 20 is able to send requests for services and transmits/receives data wirelessly from the cellular network.
Step S21: An application software requests the UE 20 to activate a sidelink communication. An application software, such as V2X (Vehicle-to-Everything) application, ProSE (Proximity Services) application, navigation, instant message, traffic monitoring (Public Safety service), vehicle tracking, auto driving, or location service application, is installed/pre-installed and executed by the ECU 40 or ASIC/CPU 22. The application software is placed in an application layer (also called Upper Layer). The application software requests the UE 20 to activate a sidelink communication or provide the corresponding services which is identified by a PSID (Provider Service Identifier) in the request.

The application software sends a request with an Application Layer ID (Identification) and Application ID (AID) to a lower layer to activate a sidelink communication. The application software may decide/select a communication type of sidelink automatically or manually (made by a user of the UE 20 or device 10) for data transmission via sidelink. The communication type is one of broadcast, groupcast and unicast. If the application software does not decide/select the communication type, a functional layer may decide/select the communication type based on a service type selected by the application software. The service type includes a ProSe, V2X, D2D (Device to Device), Ranging/Sidelink Positioning and so on. The service type reflects to a service performed by the application software. The selection allows data packets from the application software (Application Layer) to be passed to a AS layer (Access Stratum Layer) for sidelink communication. The application software also determines QoS parameters and passes them to the AS layer.

AS layer determines a layer-2 ID (as a source layer-2 ID if UE 20 is the source of sidelink data) which is used for frame transmission over a PC5 interface. The layer-2 ID is selected from a part of WMI (World Manufacturer Identifier) code, VIN (Vehicle Identification Number), IMEI (International Mobile Equipment Identity), SUCI (Subscription Concealed Identifier), 5G-GUTI (5G Globally Unique Temporary Identifier), TMSI (Temporary Mobile Subscriber Identity), random IPv6 (Internet Protocol version 6) address or a IPv6 address assigned by the cellular network. Please be noted AS layer may determine different layer-2 IDs for different communication types or services.

The UE 20 is able to receive common resource pools for sidelink communication from the broadcasting of SIB (System Block) from the cellular network. Resource pools include radio parameters (such as time and frequency resources) for sidelink communication which are appliable to several cells. Therefore, the UE may use the same radio parameters when moving in adjacent cells or spaced cells. On the other hand, the UE 20 is able to initiate a Sidelink UE Information procedure to request the specific resource pools for sidelink communication. In the Sidelink UE Information procedure the UE 20 indicates what type of resource pools it requests. For example, the UE 20 requests specific resource pools for sidelink discovery, sidelink positioning, general communication, V2X sidelink and indicates what the preferences are, such as frequency/carrier index and synchronization reference type. The UE 20 may receive a grant message or RRC signaling from the cellular network to respond its requests. Having the common/specific resource pools, the UE is able to activate the sidelink communication.

Sidelink communication is able to work in either of modes 1 and 2. In mode 1 the UE 20 enters or is in the RRC-Connected state and receives the specific resource pools assigned from the cellular network. The UE 20 sends a request of data transmission on sidelink (with Application Layer ID and Application ID) to the cellular network and receives a grant message or signaling from the cellular network to determine a schedule of data transmission. The grant may be a random or semi-static grant. After the grant message or signaling is received, the UE 20 establishes a sidelink communication (referring to a PC5 interface) and starts to broadcast sidelink data (with a source layer-2 ID and a destination layer-2 ID) to another UE, as well as receive sidelink data from another UE. The sidelink data may be in an IP or non-IP PDU format. PSSCH (Physical Sidelink Shared Channel) is one of sidelink channels used to carry the sidelink data. It supports the modulation of QPSK, 16 QAM, and 64 QAM. PSCCH (Physical Sidelink Control Channel) is able to carry SCI (Sidelink Control Information) as well. The UE 20 is able to transmit sidelink data and SCI on different RB (Resource Block) on PSSCH and/or PSCCH. Please be noted that sidelink communication follows a procedure named listening before transmitting which means the UE 20 shall monitor/listen the behaviors on PSSCH before sending sidelink data on PSSCH.

The cellular network determines whether the UE 20 shall enter a mode 2 from the mode 1 of sidelink communication based on the factors of level of QoS or resource usage. In mode 2 the UE 20 relies on the resource pools pre-configured or received in mode 1 to determine the parameters of the resource pools for data transmission on PSSCH autonomously. The determination of the parameters of the resource pools is randomly or after listening the behaviors on PSSCH. When entering the mode 2, the RRC state of UE 20 may be RRC-Connected, RRC-Idle or RRC-Inactive (no matter the UE 20 it is within or outside the coverage of the cellular network). If the UE 20 is outside the coverage of the cellular network, the UE 20 has to work in the mode 2.
Step S22: The application software determines its location with the assistance from satellites, drones or the cellular network. There are several ways to calculate the received reference data to determine the location (latitude and longitude) of the UE 20. A first way to calculate the GNSS data from GNSS. In this way the sidelink may work in either mode 1 or 2. Another way is to calculate the arrival time difference on reference data, such as DL PRS (downlink positioning reference signals) from different base stations via the UU interface. UE 20 is able to find its distances away from the base stations based on the calculation. When location of the base stations is received, the UE 20 is able to determine its location based on the calculation. In this way the UE 20 works in mode 1 of the sidelink communication.

An application server (or an application function), such as V2X or ProSe application server, is set up either inside or outside the cellular network to provide services requested by the application software. The application server is able to configure the parameters of the services based on the requests and resources. When the UE 20 connects to the cellular network, the cellular network is able to direct the messages from the application software to the application server via the UU interface.

LMF (Location Management Function) is set up inside the cellular network in order to support/decide methodologies of location (including location, time stamp, direction, velocity and so on) calculation of the UE 20, and provides services related to the location. When the methodology of location calculation is decided, the UE 20 will forward its measurements to the LMF for further calculation in order to figure out the location. The LMF is able to feedback the calculated location to the UE 20. If the UE 20 is able to complete the calculation, it will send a copy of the location to an Access and Mobility Management Function (AMF) of the cellular network.

LBS (Location-Based Service) or LCS (Location Services) provider is usually set up outside the cellular network and able to calculate the location of the UE 20 and provide location related service to the UE 20. For example, LBS or LCS provider communicates with the UE 20 via the cellular network and requests the UE 20 to provide its measurements to the LBS or LCS provider. After having the measurements, LBS or LCS provider is able to calculate the location of UE 20 and provide location related service to the UE 20 accordingly.

The cellular network, LBS or LCS provider may further record and trace the location of the UE 20. Moreover, the cellular network, LBS or LCS provider is able to predict the location of the UE 20. According to the location prediction, the cellular network is able to estimate whether the UE 20 will enter a fixed cell or leaving the current cell and therefore instructs the UE 20 to initiate a handover procedure in advance.

Generally speaking, the above calculation of location of the UE 20 is 2D. With the assistance of attitude sensor, the UE 20 is able to calculate a 3D location expressed by latitude, longitude and altitude. The UE 20 is able to determine its velocity and direction based on the change of location of the UE 20. When having the location, the UE 20 sends the location to the application software, as well as the application server and/or LMF.

RSU provides similar functions of a base station of the cellular network but focuses on the communication with vehicle via sidelink. The RSU is preferred to be implemented on a traffic signal, street lamp, telegraph pole, electric box, bus stop, gantry, RU (Radio Unit), CU (Central Unit) or the likes which is substantially stationary and its location is known/calculated. RSU links to the cellular network wired (preferred) or wirelessly (4G/5G/WiFi). The UE 20 broadcasts its vehicle messages to the RSU via the PC5 interface and receive third-party vehicle messages broadcasted by the RSU via the PC5 interface. Moreover, The RSU broadcasts traffic messages, such as traffic light status or traffic information to the UE 20. Therefore, with the traffic message and third-party vehicle messages, the application software is aware of the current traffic situation and take an action to react.
Step S23: The application software receives an operation report from a sensor 42. As mentioned, the sensor 42 is able to measure and determine whether the brake, tires, battery bank or altitude sensor of the device 10 works normal or abnormal and generate an operation report accordingly. The operation report may indicate the operation is normal or abnormal or provide a measurement to the application software to make a determination. The application software is supposed to receive the operation report regularly or when the operation is abnormal. The sensor 42 or the application software determines whether the operation is abnormal by comparing the measurement with more than one threshold For example, a first threshold reflects to a warning situation, such as the temperature is 75-degree C. and a second threshold reflects to a urgent situation, such as the temperature is 95-degree C.
Step S24: The application software broadcasts a vehicle message periodically via the sidelink communication if the operation report indicates normality. If determining the device 10 is operating normally based on the received operation report(s), the application software instructs UE 20 to broadcast the vehicle message which includes the location of the UE 20, Layer-2 ID or Application Layer ID and additional information, on PSSCH periodically. Additional information includes a SCI for decoding and processing the messages on PSSCH accurately. The additional information may not be transmitted on PSSCH, but PSCCH. Periodicity may be implemented by a SPS (Semi-Persistent Scheduling) mechanism and last for a certain time. For example, by setting a parameter RRI (Resource Reservation Interval) as 100 ms in the SCI broadcasted with the vehicle message on PSSCH, another UE senses the vehicle message on PSSCH and understand the UE 20 will broadcast another vehicle message in 100 ms. If the velocity of the device 10 is 120 KM/hour, it is equal to 3.33 meters/100 milliseconds. Hence, the periodicity of broadcasting satisfies most of the demands for vehicle management. The UE 20 may work in either mode 1 or 2 of the sidelink communication.
Step S25: The application software instructs the UE 20 to broadcast the vehicle message via the sidelink communication in an urgent way if the operation report indicates abnormality. The urgent way is implemented by modifying at least one transmission configuration of the UE 20. If the received operation report(s) indicate the device 10 operations abnormally, the application software enters an urgent state and instructs the UE 20 to broadcast the vehicle message on sidelink more frequently. For example, the application software instructs the UE 20 to set the RRI as 50 ms. Alternatively, the application software instructs the UE 20 to send the vehicle messages via both SPS and random access. Alternatively, the application software instructs the UE 20 to initiate two SPS to increase the frequency of sidelink data transmission. Alternatively, the application software instructs the UE 20 to halt/disable/leave a power saving mode or Discontinuous Reception (DRX) mode in order to broadcast the vehicle message on PSSCH once 100 milliseconds continuously. Because UE 20 does not enter/stay the power saving mode or DRX mode, the frequency of data transmission is inherently increased. Alternatively, the application software instructs the UE 20 to change the MCS (Modulation and Coding Scheme) increase the number of RB for the data transmission. By using a lower rate of MCS and higher number of RB, the signal-to-noise ratio (SNR) is increased and the likelihood of data re-transmission is reduced. In view of data transmission, the frequency or efficiency of data transmission is increased. Alternatively, the application software issues Transmit Power Control (TPC) commands to the UE 20 to increase the power of transmission power. Hence, the SNR is increased and data re-transmission is reduced. Besides entering the urgent state and instructs the UE 20 to broadcast the vehicle message on sidelink as described above, the application software may instruct the UE 20 to enter an urgent state. In the urgent state, the transmission configuration of UE 20 is modified in order to broadcast the received vehicle message on sidelink more frequently.

Moreover, the application software or the UE 20 is able to generate a cause value corresponding to the abnormal status, such as cause value “1” refers to low tire pressure and cause value “2” refers to tire pressure unknown. The cause value and the vehicle message are broadcasted together. Therefore, another application software of another UE is able to determine what type of abnormality the device 10 is based on the cause value. The UE 20 may work in either mode 1 or 2 of the sidelink communication.

When another UE receives the vehicle message, its application software may give its user an alarm or trigger some actions immediately. For example, it may give its user an alarm via light or beep, or make itself slow down immediately.
Step S26: The application software sends the vehicle message to the cellular network via a UU interface. The application software instructs the UE 20 to send the vehicle message (preferable with the cause value) to the application server or the LMF of the cellular network via the UU interface. If the UE 20 is not in RRC-Connected state, it leaves the current state and enters the RRC-Connected state in order to transmit the vehicle message to the cellular network. As discussed, before sending the vehicle message to the cellular network, the UE 20 sends a request of data transmission first. After receiving the grant from the cellular network, the UE 20 sends the vehicle message to the application server of LMF. Due to the movement of the UE 20, the connection with the UE 20 may be a base station, satellite or drone. A handover procedure may be initiated in advance before sending the request of data transmission.

When the application server or the LMF receives the vehicle message, it may broadcast a message (preferable with the cause value) to all UEs within the coverage of the same cell to inform the abnormality of the device 10. When another UE or application software receives that message, it may give their users alarms or trigger some actions immediately. For example, another UE or application may give their user an alarm via light or beep, or make its device slow down immediately.

FIG. 3 illustrates the second embodiment of method of management of sidelink communication. Steps S30-S32 are similar with steps S20-S22, so the detailed explanation is skip.
Steps S33: The application software calculates a distance value by comparing its and a third-party location from a third-party vehicle message received from the sidelink communication. The UE 20 keep listening messages on sidelink communication. If a third-party vehicle message is broadcasted by a third party, the UE 20 is able to decode the third-party vehicle message and determine the third-party's location. The UE 20 passes its location calculated in step S32 to the application software, as well as the third-party location, the application software is able to calculate a distance value indicating a distance between the UE 20 and the third party.
Steps S34: The application software broadcasts a vehicle message periodically via the sidelink communication if the distance value is higher than a threshold. If the distance value is higher than a threshold, it means the UE 20 keeps a safe distance from another UE/device, therefore it takes a similar step as step S24 to broadcasts its vehicle message periodically on sidelink.
Steps S35: The application software instructs the UE 20 to broadcast a vehicle message via the sidelink communication in an urgent way if the distance value is lower than the threshold. If the distance value is lower than a threshold, it means the UE 20 is close to another UEs/devices and the reaction time may not be enough if an accidence is happened on either one. Therefore, the application software takes a similar step as step S25 to broadcast its vehicle message in an urgent way.
Steps S36: The application software sends the vehicle message to the cellular network via a UU interface. The application software takes a similar step as step S26 to send its vehicle message to the cellular network via the UU interface.

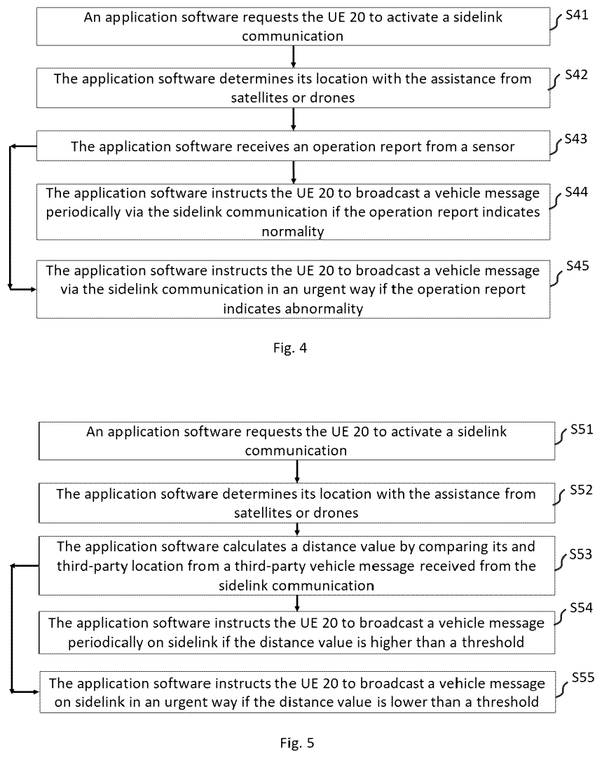

FIG. 4 illustrates the third embodiment of method of management of sidelink communication. In this embodiment the UE 20 does not camp on or register to a cellular network for unknown reasons, a similar step as step S20 does not be taken in the third embodiment.
Steps S41: An application software requests the UE 20 to activate a sidelink communication. The application software requests the UE 20 to activate a sidelink communication. Because the UE 20 does not connect to the cellular network, the UE 20 activates a sidelink communication in mode 2, not mode 1. In mode 2 the UE 20 relies on the resource pools pre-configured or received from the cellular network in the prior connection to determine the parameters of the resource pools for data transmission on sidelink autonomously. The UE 20 may be in either RRC-Idle or RRC-Inactive state.
Steps S42: The application software determines its location with the assistance from satellites or drones. Step S42 is similar with step S22 but only have the assistance from satellites or drones.
Steps S43: The application software receives an operation report from a sensor. Step S43 is similar with step S23.
Steps S44: The application software instructs the UE 20 to broadcast a vehicle message periodically via the sidelink communication if the operation report indicates normality. Step S44 is similar with step S24 but the sidelink communication works in mode 2.
Steps S45: The application software instructs the UE 20 to broadcast a vehicle message via the sidelink communication in an urgent way if the operation report indicates abnormality. Step S45 is similar with step S25 but the sidelink communication works in mode 2.

FIG. 5 illustrates the fourth embodiment of method of management of sidelink communication. In this embodiment the UE 20 does not camp on or register to a cellular network for unknown reasons, a similar step as step 30 does not take in the third embodiment. Steps S51-S52 are similar with steps S41-S42, so the detailed explanation is skip.
Steps S53: The application software receives an operation report from a sensor. Step S53 is similar with step S33 but the sidelink communication works in mode 2.
Steps S54: The application software instructs the UE 20 to broadcast a vehicle message periodically via the sidelink communication if the distance value is higher than a threshold. Step S54 is similar with step S34 but the sidelink communication works in mode 2.
Steps S55: The application software instructs the UE 20 to broadcast a vehicle message via the sidelink communication in an urgent way if the distance value is lower than a threshold. Step S55 is similar with step S35 but the sidelink communication works in mode 2.

As a software application provider, the above embodiments provide efficient and prompt solutions to the public to satisfy their demand. The error message is processed and transmitted or broadcasted to another entity not only promptly but also frequently. Therefore, the entity is aware of the error message or the traffic event, and have enough lead time to figure a way to handle it. The solution does not cause the increase of hardware cost.

While the embodiments have been described in connection with various aspects, it will be understood that the embodiments are capable of further modifications. This application is intended to cover any variations, uses or adaptation of the embodiments following, in general, the principles of the embodiments, and including such departures from the present disclosure as come within the known and customary practice within the art to which the embodiments pertain.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of management of sidelink communication by an application software, comprising:
requesting a UE to activate a sidelink communication;
determining the UE's location with the assistance from satellites or a cellular network;
receiving an operation report from a sensor;
instructing the UE to broadcast a vehicle message periodically via the sidelink communication if the operation report indicates normality; and
instructing the UE to broadcast the vehicle message via the sidelink communication in an urgent way if the operation report indicates abnormality.

2. The method of claim 1, further comprising:
instructing the UE to send the vehicle message to the cellular network via a UU interface.

3. The method of claim 2, further comprising:
camping on and registering to the cellular network before the step to request the UE to activate the sidelink communication.

4. The method of claim 2, the urgent way is to increase the frequency of broadcasting the vehicle message.

5. The method of claim 2, the urgent way is implemented by modifying at least one transmission configuration of the UE.

6. The method of claim 2, the urgent way is to disable a power saving mode.

7. The method of claim 2, the urgent way is to reduce a value of a parameter RRI.

8. The method of claim 2, further including:
Generating a cause value corresponding to the operation report.

9. The method of claim 2, a parameter of a plurality of resource pools for the sidelink communication used by the UE is applicable to two adjacent cells or spaced cells.

10. The method of claim 2, the operation report is generated based on a value generated by the sensor.

11. A method of management of sidelink communication by an application software, comprising:
requesting a UE to activate a sidelink communication;
determining the UE's location with the assistance from satellites;
receiving an operation report from a sensor;
instructing the UE to broadcast a vehicle message periodically via the sidelink communication if the operation report indicates normality, wherein the UE is in either RRC-Idle or RRC-Inactive mode and the sidelink communication works in mode 2; and
instructing the UE to broadcast the vehicle message via the sidelink communication in an urgent way if the operation report indicates abnormality.

12. The method of claim 11, the urgent way is to increase the frequency of broadcasting the vehicle message.

13. The method of claim 11, further including:
Generating a cause value corresponding to the operation report.

14. A method of management of sidelink communication by an application software, comprising:
requesting a UE to activate a sidelink communication;
determining the UE's location with the assistance from satellites or a cellular network;
calculating a distance value by comparing its and a third-party location from a third-party vehicle message received from the sidelink communication;
instructing the UE to broadcast a vehicle message periodically via the sidelink communication if the distance value is higher than a threshold; and
instructs the UE to broadcast the vehicle message via the sidelink communication in an urgent way if the distance value is lower than the threshold.

15. The method of claim 14, further comprising:
instructing the UE to send the vehicle message to the cellular network via a UU interface.

16. The method of claim 15, further comprising:
camping on and registering to the cellular network before the step to request the UE to activate the sidelink communication.

17. The method of claim 15, the urgent way is to increase the frequency of broadcasting the vehicle message.

18. The method of claim 15, the urgent way is implemented by modifying at least one transmission configuration of the UE.

19. The method of claim 15, the urgent way is to disable a power saving mode.

20. The method of claim 15, a parameter of a plurality of resource pools for the sidelink communication used by the UE is applicable to two adjacent cells or spaced cells.
